(19) United States
(12) Patent Application Publication
(10) Pub. No.: US 2014/0217714 A1
(43) Pub. Date: Aug. 7, 2014

(54) CHASSIS STRUCTURE

(71) Applicants: Yoshihide Sekiya, Chiryu-shi (JP); Akira Hasegawa, Kakegawa-shi (JP); Yukihide Kimura, Gotenba-shi (JP)

(72) Inventors: Yoshihide Sekiya, Chiryu-shi (JP); Akira Hasegawa, Kakegawa-shi (JP); Yukihide Kimura, Gotenba-shi (JP)

(73) Assignee: TOYOTA JIDOSHA KABUSHIKI KAISHA, Toyota-shi, Aichi (JP)

(21) Appl. No.: 14/009,548

(22) PCT Filed: Apr. 18, 2011
(86) PCT No.: PCT/JP2011/059528

§ 371 Date: Oct. 3, 2013

(51) Int. Cl. B62D 61/04

(52) U.S. Cl. CPC B62D 61/04
USPC 280/781

(57) ABSTRACT

A chassis structure used in a vehicle having a front, a left, a right, and a rear wheel, including: two front oblique beams disposed to sandwich the front wheel and extending from a central portion of the chassis structure respectively toward between the front wheel and the right wheel and toward between the front wheel and the left wheel such that distal end portions of the respective two front oblique beams are located on a right side and a left side of the front wheel, respectively; and two rear oblique beams disposed to sandwich the rear wheel and extending from the central portion respectively toward between the rear wheel and the right wheel and toward between the rear wheel and the left wheel such that distal end portions of the respective two rear oblique beams are located on a right side and a left side of the rear wheel, respectively.

### TECHNICAL FIELD

The present invention relates to a vehicle having: a single front wheel disposed at a front portion thereof; and a left wheel and a right wheel that are respectively disposed at a left portion an a right portion thereof and that is located rearward of the front wheel. In particular, the present invention relates to a chassis structure used in such a vehicle.

### BACKGROUND ART

There has been conventionally proposed a vehicle having: a single front wheel; and a left wheel and a right wheel disposed rearward of the front wheel, as described in the following Patent Literature 1. There has been recently proposed a vehicle as described in the following Patent Literature 2. This vehicle has, in addition to the three wheels, a single rear wheel disposed rearward of the left And right wheels.

### CITATION LIST

### Patent Literature

Patent Literature 1: JP-A-2006-130985
Patent Literature 2: CN 1304237 C

### SUMMARY OF INVENTION

### Technical Problem

Each of the vehicles indicated above (hereinafter referred to as “special wheel-arrangement vehicle” where appropriate) differs from an ordinary vehicle having a front left wheel and a front right wheel as two front wheels and a rear left wheel and a rear right wheel as two rear wheels (hereinafter referred to as “four-corner wheel-arrangement vehicle” where appropriate. Accordingly, as a matter of course, the structure of chassis used in the special wheel-arrangement vehicle differs from the structure of chassis used in the four-corner wheel-arrangement vehicle. There is plenty of room for improvement in the chassis structure used in the special wheel-arrangement vehicle, and it is possible to enhance the utility of the special wheel-arrangement vehicle by making some improvements. The present invention has been made in the light of such situations, and it is therefore an object of the invention to provide a chassis structure for improving the utility of the special wheel-arrangement vehicle.

### Solution to Problem

To achieve the object indicated above, a chassis structure according to the present invention that is used for a special wheel-arrangement vehicle includes two front oblique beams as a pair that are disposed so as to sandwich the front wheel therebetween, one of the two front oblique beams extending from a central portion of the chassis structure surrounded by a front wheel, a right wheel, and a left wheel toward between the front wheel and the right wheel such that a distal end portion of the one of the two front oblique beams is located on a right side of the front wheel while the other of the two front oblique beams extends from the central portion toward between the front wheel and the left wheel such that a distal end of the other of the two front oblique beams is located on a left side of the front wheel.

### Advantageous Effects of Invention

Even where the vehicle in which the chassis structure according to the present invention is used collides with other vehicle, an obstacle or the like, at its right front portion or left front portion, it is possible to suppress deformation of a cabin interior space owing to the front oblique beams, so that the safety of the vehicle occupant can be ensured. Owing to such advantages, the utility of the special wheel-arrangement vehicle can be enhanced by using the chassis structure according to the present invention in the special wheel-arrangement vehicle.

### Forms of Invention

There will be explained various forms of an invention which is considered claimable (hereinafter referred to as “claimable invention” where appropriate). Each of the forms is numbered like the appended claims and depends from the other form or forms, where appropriate. This is for easier understanding of the claimable invention, and it is to be understood that combinations of constituent elements that constitute the invention are not limited to those described in the following forms. That is, it is to be understood that the claimable invention shall be construed in the light of the following description of various forms and embodiments. It is to be further understood that, as long as the claimable invention is construed in this way, any form in which one or more constituent elements is/are added to or deleted from any one of the following forms may be considered as one form of the claimable invention.

In the following forms, the form (1) corresponds to claim 1. A form in which the technical features of the form (2) are added to claim 1 corresponds to claim 2. A form in which the technical features of the form (6) are added to claim 1 or 2 corresponds to claim 3. A form in which the technical features of the form (7) are added to claim 3 corresponds to claim 4. A form in which the technical features of the form (8) are added to claim 4 corresponds to claim 5. A form in which the technical features of the form (9) are added to any one of claims 3-5 corresponds to claim 6. A form in which the technical features of the form (3) are added to any one of claims 1-6 corresponds to claim 7. A form in which the technical features of the form (4) are added to claim 7 corresponds to claim 8. A form in which the technical features of the form (5) are added to claim 7 or 8 corresponds to claim 9. A form in which the technical features of the forms (10) and (11) are added to any one of claims 1-9 corresponds to claim 10. A form in which the technical features of the form (12) are added to claim 10 corresponds to claim 11. A form in which the technical features of the form (13) are added to claim 10 corresponds to claim 12.

(1) A chassis structure used in a vehicle having a single front wheel that is disposed at a middle of a front portion of the vehicle in a width direction of the vehicle and a left wheel and a right wheel that are respectively disposed at a left portion and a right portion of the vehicle and that are located rearward of the front wheel, the chassis structure being for holding the front wheel, the right wheel, and the left wheel and comprising two front oblique beams as a pair that are disposed so as to sandwich the front wheel therebetween, one of the two front oblique beams extending from a central portion of the chassis structure surrounded by the front wheel, the right wheel, and the left wheel toward between the front wheel and the right wheel such that a distal end portion of the one of the two front oblique beams is located on a right side of the front wheel while the other of the two front oblique beams extends from the central portion toward between the front wheel and the left wheel such that a distal end portion of the other of the two front oblique beams is located on a left side of the front wheel.

The vehicle in which the chassis structure described in this form is used is the above-indicated special wheel-arrangement vehicle. The vehicle may be a three-wheel vehicle having only the front wheel, the left wheel, and the right wheel or may be a vehicle further having, in addition to the three wheels, a single rear wheel disposed rearward of the left and right wheels (hereinafter referred to as “diamond-shaped wheel-arrangement vehicle” where appropriate). The chassis structure described in this form is constituted so as to include a chassis frame functioning as a framework of the chassis of the vehicle. That is, the chassis structure described in this form is not limited to a chassis structure used in a vehicle in which the chassis frame and a body are formed separately from each other, i.e., a vehicle of the so-called separate frame type, but may include a chassis structure used in a vehicle in which the chassis frame and the body are formed integrally with each other, i.e., a vehicle of the so-called frameless body type (monocoque body type).

Initially, there is considered a case in which the four-corner wheel-arrangement vehicle having the left and right front wheels and the left and right rear wheels collides with other vehicle, an obstacle or the like, at its front portion. In the four-corner wheel-arrangement vehicle, the wheels are respectively disposed at both of left and right corners of its front portion. Even where the vehicle collides at any of its direct front portion, right front portion, and left front portion, deformation of a cabin interior space of the vehicle is suppressed by a chassis structure and the like by which the front wheels are held, so that the safety of a vehicle occupant is guaranteed or ensured. In the special wheel-arrangement vehicle, in contrast, the front wheel is disposed at the widthwise middle in the front portion of the vehicle. Accordingly, where the vehicle collides at its left front portion or right front portion, namely, in the event of the so-called offset collision, it is very important to ensure the safety of the vehicle occupant. Moreover, in the special wheel-arrangement vehicle, it is contemplated that, in view of the above wheel-arrangement, the right front portion and the left front portion of the vehicle body are roundly shaped. Where the vehicle body is thus shaped in the special wheel-arrangement vehicle, a stroke amount for absorbing an impact in the offset collision becomes small. Accordingly, it is particularly important to ensure the safety of the vehicle occupant.

The chassis structure described in this form includes a beam extending from its central portion obliquely to the forward right and a beam extending from its central portion obliquely to the forward left. According to the thus constructed chassis structure, it is possible to suppress or reduce deformation of the cabin interior space of the vehicle in the event of the offset collision owing to the front oblique beams. That is, the special wheel-arrangement vehicle in which is used the chassis structure according to this form guarantees the safety of the vehicle occupant in the event of the offset collision, resulting in enhanced utility of the vehicle.

The “two front oblique beams as a pair” described in this form are disposed as described above so as to constitute a part of the framework of the chassis structure. That is, each of the two front oblique beams need not to be independent as one member or component. The two front oblique beams may be formed integrally with each other. Further, each of the two front oblique beams may be formed integrally with other beam(s) of the chassis structure. Moreover, where the chassis structure is used in the vehicle of the above-indicated frameless body type, each of the two front oblique beams may be formed integrally with the body.

The chassis structure includes various other beams, in addition to the two front oblique beams, as explained later in detail. In the present chassis structure, like the two front oblique beams, each of various other beams need not to be independent as one member or component, but may be formed integrally with other beam(s) or may be formed integrally with the body.

(2) The chassis structure according to the form (1), wherein each of the two front oblique beams is disposed such that the distal end portion thereof is located frontward of a cabin interior space formed in the vehicle in which the chassis structure is used.

According to the chassis structure described in this form, the cabin interior space of the vehicle deforms only after the front oblique beams have deformed to a certain degree. Accordingly, the chassis structure described in this form is suitable for ensuring the safety of the vehicle occupant. Where the vehicle in which the chassis structure is used is configured such that seats are provided respectively on a right side and a left side of the central portion of the chassis structure, each of the two front oblique beams in this form is disposed so as to extend from the central portion up to a position that is more frontward of a position at which the toe of the vehicle occupant is located.

(3) The chassis structure according to the form (1) or (2), further comprising a front center beam disposed so as to extend from the central portion toward above the front wheel.

In the chassis structure described in this form, the number of beams that extend frontward from the central portion is increased, thereby increasing the strength of the front portion of the vehicle. It is accordingly possible to enhance the safety of the vehicle occupant in the collision of the vehicle at the front portion thereof.

(4) The chassis structure according to the form (3), further comprising connection beams each of which extends between a distal end portion of the front center beam and the distal end portion of a corresponding one of the two front oblique beams so as to connect the front center beam and the corresponding one of the two front oblique beams.

In the chassis structure described in this form, the distal end portion of the front center beam and the distal end portions of the respective two front oblique beams are connected by the respective connection beams, thereby further increasing the strength of the front portion of the vehicle. In particular, bending strength of each of the front center beam and the two front oblique beams is increased. Accordingly, deformation of the vehicle is suppressed with respect to a collision in directions that intersect a direction in which any of the two front oblique beams extends, thereby ensuring the safety of the vehicle occupant.

(5) The chassis structure according to the form (3),

wherein the front wheel is a steerable wheel, and

wherein a steering shaft of the front wheel is held at the distal end portion of the front center beam.

The above-indicated front center beam extends toward above the front wheel and is accordingly suitable for holding the front wheel. The chassis structure according to this form is constituted such that the distal end portion of the front center beam is located above the front wheel and such that the front center beam holds, at the distal end portion thereof, the steering shaft of the front wheel that functions as the steerable wheel.

(6) The chassis structure according to any one of the forms (1)-(5), further comprising a main beam disposed at the central portion so as to extend in a front-rear direction of the vehicle,

wherein each of the two front oblique beams is fixed at a rear end portion thereof to a front end portion of the main beam so as to extend from the main beam.

In the chassis structure described in this form, the above-indicated “main beam” is a center of the framework of the chassis. In the present chassis structure, the center of the framework of the chassis is disposed so as to extend in the front-rear direction at the middle in the width direction of the vehicle. This form ensures spaces for disposing suspension apparatuses for the respective left and right wheels, making it possible to increase a degree of freedom in designing the suspension apparatuses. Even where the vehicle has a small width, a relatively large space can be ensured for disposing each of the suspension apparatuses for the left and right wheels. This form is particularly effective for such a vehicle with a small width.

In the chassis structure according to this form, the weight of the above-indicated main beam is relatively large. Because the main beam is disposed at a position relatively near the center of gravity of the vehicle, however, it is possible to reduce moment of inertia in yawing or rolling of the vehicle. Accordingly, this form can enhance running stability and maneuverability of the vehicle.

Where the vehicle in which the present chassis structure is used is constructed such that seats are provided respectively on the right side and the left side of the central portion of the chassis structure, for instance, the main beam may be disposed so as to extend between the two seats. According to the arrangement, the height of the main beam can be increased without increasing the height of the floor, for instance. In other words, even where the height of the main beam is increased, the height of the floor need not be increased.

(7) The chassis structure according to the form (6), further comprising a floor board,

wherein the main beam is disposed so as to protrude upward from the floor board.

In the chassis structure described in this form, the upper surface of the main beam is located at a height level higher than the floor. In this form, therefore, the gravity center position of the vehicle body can be made lower, as compared with a case in which the floor is disposed on the main beam. Where the seats are provided respectively on the left side and the right side of the main beam, the height of the seats is reduced, so as to realize the vehicle that ensures ease of ingress and egress.

(8) The chassis structure according to the form (6) or (7), wherein the two front oblique beams and the main beam are located in one plane.

In this form, the height of the two front oblique beams is made equal to the height of the main beam. Accordingly, the front oblique beams can be supported on the rear side thereof in a collision of the vehicle at the front portion. That is, where the chassis structure according to this form is used, the strength of the vehicle in the front-rear direction is increased, making it possible to further enhance the safety of the vehicle occupant.

Where this form is combined with the above-indicated form in which the main beam is disposed so as to protrude upward from the floor, the height of the framework of the chassis can be increased without increasing the height of the floor even if the vehicle in which the chassis structure is used is relatively small. That is, in the small-sized vehicle in which is used the chassis structure with such an arrangement, the height of the framework of the chassis can be made substantially equal to the height of a bumper or the like of an ordinary-sized vehicle, so that the vehicle ensures excellent safety of the vehicle occupant.

(9) The chassis structure according to any one of the forms (6)-(8), wherein the main beam is a frame-like member having a quadrilateral shape as viewed from above.

In the chassis structure according to this form, a battery, auxiliary equipment, and so on, installed on the vehicle can be disposed inside the main beam in the form of the frame-like member. The battery, the auxiliary equipment, and so on, disposed inside the main beam can be reliably protected in a collision of the vehicle. Further, according to this form, various equipment can be disposed near the gravity center position of the vehicle body, thereby reducing the moment of inertia in yawing and rolling of the vehicle.

(10) The chassis structure according to any one of the forms (1)-(9), wherein the vehicle in which the chassis structure is used further has a single rear wheel disposed rearward of the left wheel and the right wheel.

The chassis structure described in this form is used in the above-indicated diamond-shaped wheel-arrangement vehicle.

(11) The chassis structure according to the form (10), further comprising a two rear oblique beams as a pair that are disposed so as to sandwich the rear wheel therebetween, one of the two rear oblique beams extending from the central portion toward between the rear wheel and the right wheel such that a distal end portion of the one of the two rear oblique beams is located on a right side of the rear wheel while the other of the two rear oblique beams extends from the central portion toward between the rear wheel and the left wheel such that a distal end portion of the other of the two rear oblique beams is located on a left side of the rear wheel.

According to the chassis structure of this form, in the diamond-shaped wheel-arrangement vehicle, oblique beams similar to the front oblique beams are disposed in the rear portion of the vehicle, as in the front portion of the vehicle. That is, according to this form, it is possible to suppress deformation of the cabin interior space of the vehicle and to ensure the safety of the vehicle occupant, in the event of a collision at the rear portion of the vehicle.

In the chassis structure according to this form, a rear center beam similar to the front center beam disposed at the front portion of the vehicle may be disposed for the rear wheel, such that the rear center beam extends from the central portion toward above the rear wheel. Further, where the chassis structure is configured to have the rear center beam, the features relating to the front center beam may be applied to the rear center beam. To be more specific, distal end portions of the respective two rear oblique beams may be connected to a distal end portion of the rear center beam. Further, the rear wheel may be held at the distal end portion of the rear center beam.

(12) The chassis structure according to the form (11), further comprising a main beam disposed at the central portion so as to extend in a front-rear direction of the vehicle,

wherein each of the two front oblique beams is fixed at a rear end portion thereof to a front end portion of the main beam so as to extend from the main beam while each of the two rear oblique beams is fixed at a front end portion thereof to a rear end portion of the main beam so as to extend from the main beam.

In the chassis structure described in this form, the framework of the chassis is constituted mainly by the main beam, the oblique beams that respectively extend from the main beam toward the left front portion and the right front portion, and the oblique beams that extend from the main beam toward the left rear portion and the right rear portion. The features relating to the above-indicated main beam may be applied to this form. That is, this form may be configured such that the main beam is disposed so as to protrude upward from the floor board. Further, this form may be configured such that the two front oblique beams, the two rear oblique beams, and the main beam are disposed in one plane. Moreover, this form may be configured such that the main beam is formed of a frame-like member having a quadrilateral shape.

Where the chassis structure is configured such that the main beam is disposed so as to protrude upward from the floor board and such that the two front oblique beams, the two rear oblique beams, and the main beam are disposed in one plane, seats may be provided respectively at a portion enclosed with the main beam, the right-side front oblique beam, and the right-side rear oblique beam and a portion enclosed with the main beam, the left-side front oblique beam, and the left-side rear oblique beam.

(13) The chassis structure according to the form (11), wherein front end portions of the respective two rear oblique beams and rear end portions of the respective two front oblique beams are fixed to one another at the central portion.

In the chassis structure according to this form, the framework of the chassis is formed so as to have a generally X-letter shape. In this form, the two front oblique beams and the two rear oblique beams are connected to each other without any component, member or the like interposed therebetween. Accordingly, the chassis structure is relatively simple in construction. The chassis structure according to this form may be configured such that the two front oblique beams and the two rear oblique beams are disposed so as to protrude upward from the floor board. Such a configuration enables the gravity center position of the vehicle body to be located at a lower position. Further, where seats are provided respectively between the right-side front oblique beam and the right-side rear oblique beam and between the left-side front oblique beam and the left side rear oblique beam, the height of the seats is lowered, realizing the vehicle that ensures ease of ingress and egress.

(14) The chassis structure according to any one of the forms (1)-(13), the vehicle for which the chassis structure is used has seats respectively provided on a right side and a left side of the central portion.

In the chassis structure according to this form, positions of the seats in the vehicle are limited. In the chassis structure, a part (i.e., the central portion) of the framework is present in a portion enclosed by the wheels. It is therefore desirable that the chassis structure according to this form be configured such that the central portion protrudes upward from the floor.

### BRIEF DESCRIPTION OF DRAWINGS

FIG. 1 is a schematic side view of a vehicle in which is used a chassis structure according to a first embodiment of the claimable invention.

FIG. 2 is a schematic plan view of the vehicle shown in FIG. 1.

FIG. 3 is a perspective view showing chassis of the vehicle shown in FIG. 1.

FIG. 4 is a plan view showing the chassis of the vehicle shown in FIG. 1.

FIG. 5 is a side view showing the chassis of the vehicle shown in FIG. 1.

FIG. 6 is a front view showing the chassis of the vehicle shown in FIG. 1.

FIG. 7 is a plan view showing a chassis structure according to a modified example of the first embodiment.

FIG. 8 is a plan view showing a chassis structure according to a second embodiment of the claimable invention.

### DESCRIPTION OF EMBODIMENTS

There will be hereinafter explained in detail typical embodiments of the claimable invention with reference to drawings. It is to be understood that the claimable invention may be embodied with various changes and modifications based on the knowledge of those skilled in the art, in addition to the following embodiments and various forms described in the FORMS OF INVENTION.

### First Embodiment

### Configuration of Vehicle in which Chassis Structure is Used

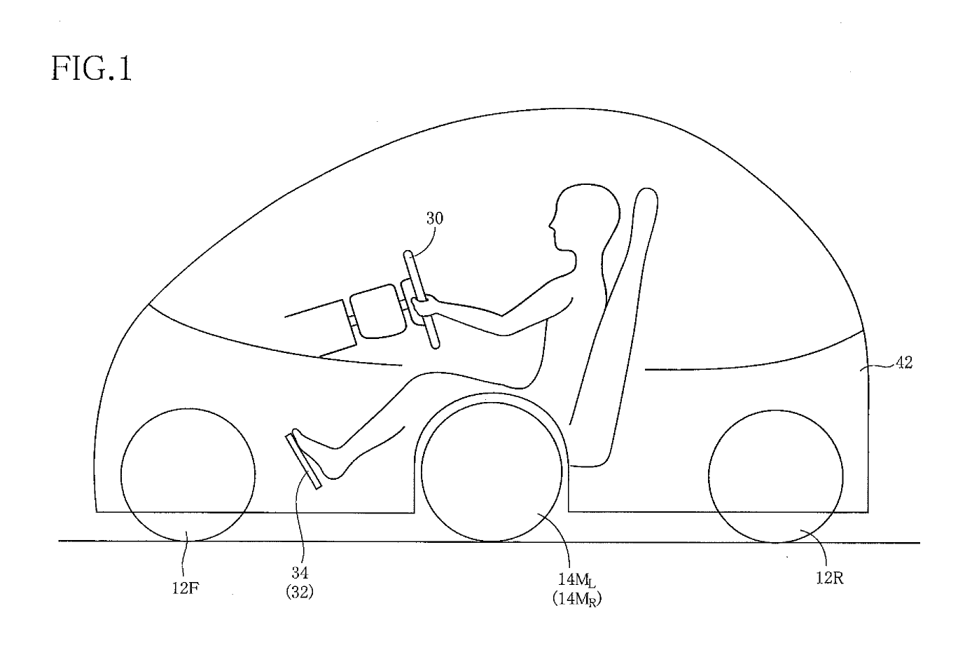

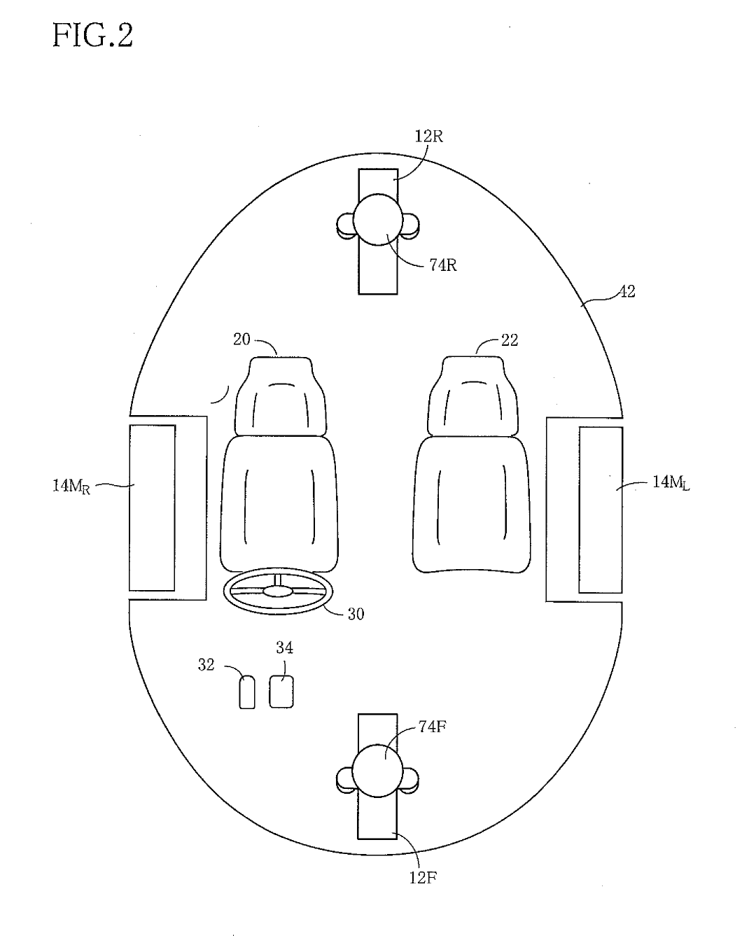

FIG. 1 shows a vehicle in which is used a chassis structure according to a first embodiment of the claimable invention. This vehicle is a small-sized vehicle expected as a next-generation commuter vehicle. In this vehicle, wheels are arranged in a diamond or rhombus shape. This vehicle includes: a front wheel 12F disposed at a front portion of the vehicle; a left wheel 14M_{L} and a right wheel 14M_{R} that are respectively disposed at a left portion and a right portion of the vehicle and that are located rearward of the front wheel 12F; and a rear wheel 12R disposed rearward of the left wheel 14M_{L} and the right wheel 14M_{R}. As apparent from the plan view of FIG. 2 showing the vehicle, the front wheel 12F and the rear wheel 12R are disposed at the middle in the width direction of the vehicle. In the following explanation, the front wheel 12F and the rear wheel 12R are collectively referred to as the wheel 12 where it is not necessary to distinguish the front wheel 12F and the rear wheel 12R form each other. The left wheel 14M_{L} and the right wheel 14M_{R} are collectively referred to as the wheel 14 where it is not necessary to distinguish the left wheel 14M_{L} and the right wheel 14M_{R} from each other. Like the wheels 12, 14, each of constituent elements, parameters, etc., that relates to one of the front wheel 12F, the rear wheel 12R, the left wheel 14M_{L}, and the right wheel 14M_{R} is expressed together with one of F, M_{L}, M_{R}, R respectively corresponding to the front wheel, the left wheel, the right wheel, and the rear wheel, as a suffix to indicate a wheel position.

In the present vehicle, the front wheel 12F and the rear wheel 12R are steerable wheels while the left wheel 14M_{L} and the right wheel 14M_{R} are not steerable wheels. The left wheel 14M_{L} and the right wheel 14M_{R} are drive wheels (i.e., wheels that are to be driven for driving the vehicle) while the front wheel 12F and the rear wheel 12R are not drive wheels. Further, all of the front wheel 12F, the left wheel 14M_{L}, the right wheel 14M_{R}, and the rear wheel 12R are brakable wheels (i.e., wheels that are to be braked for braking the vehicle).

As shown in FIG. 2, the vehicle is provided with a seat 20 and a seat 22. The right-side seat 20 is a driver's seat while the left-side seat 22 is a passenger's seat. The present vehicle is provided with three operating members for the seat 20 as the driver's seat. The three operating members are operable by a vehicle operator or driver for operating the vehicle. One of the three operating members is a steering wheel 30 as a steering operating member for turning the vehicle. Another one of the three operating members is an accelerator pedal 32 as an acceleration operating member for accelerating the vehicle. Still another one of the three operating members is a brake pedal 34 as a brake operating member for decelerating the vehicle.

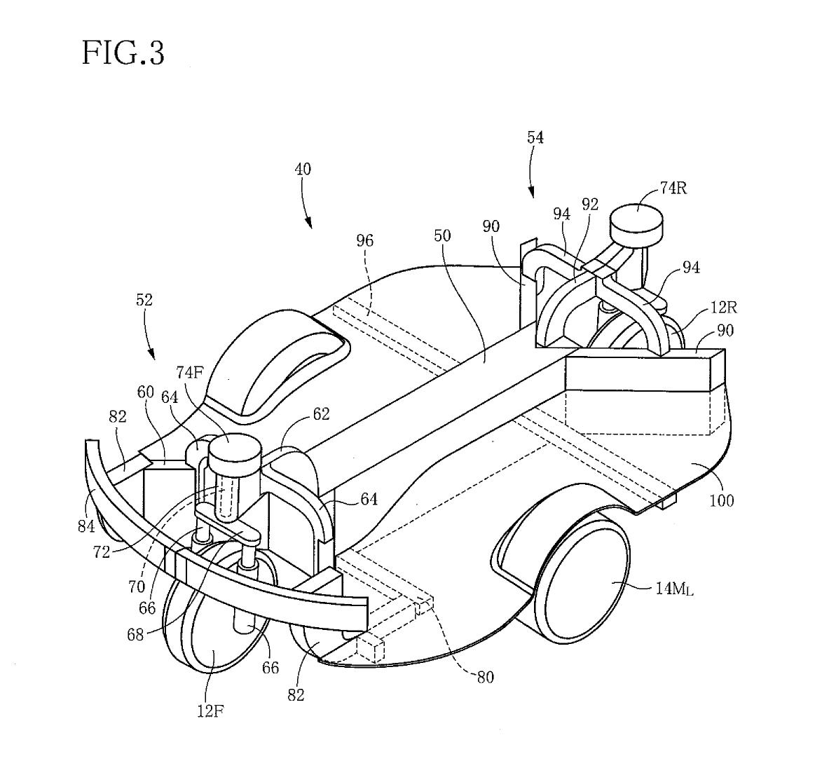

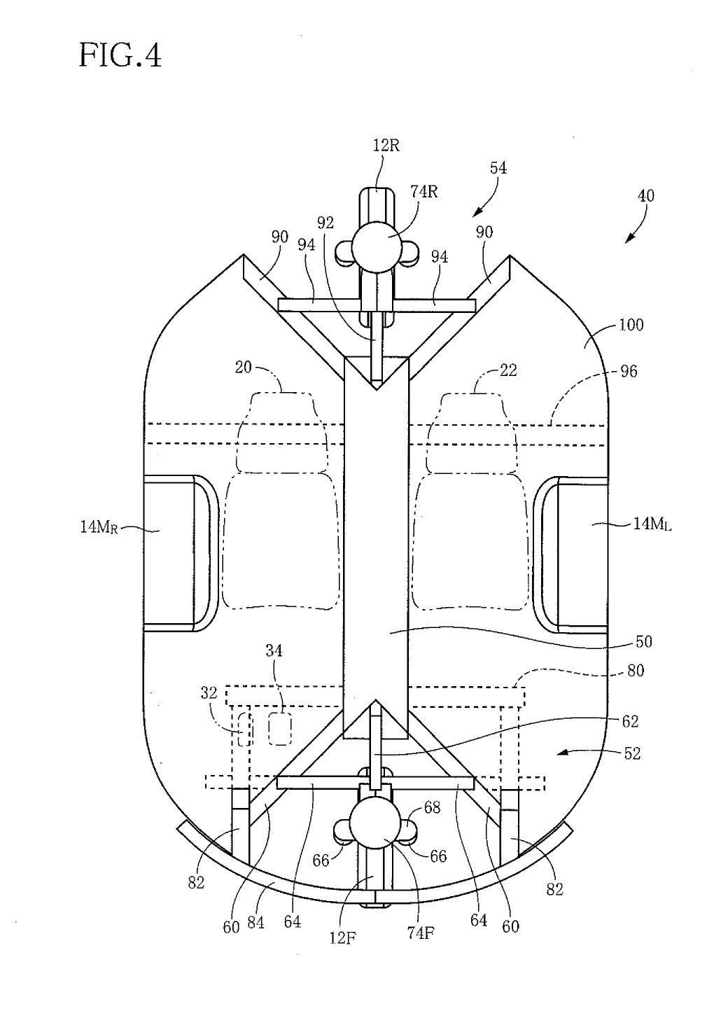

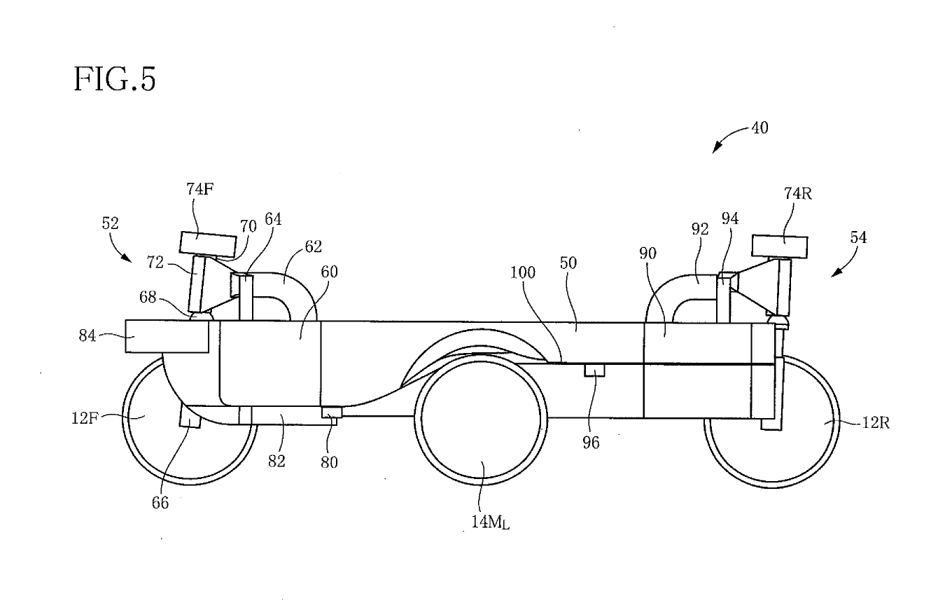

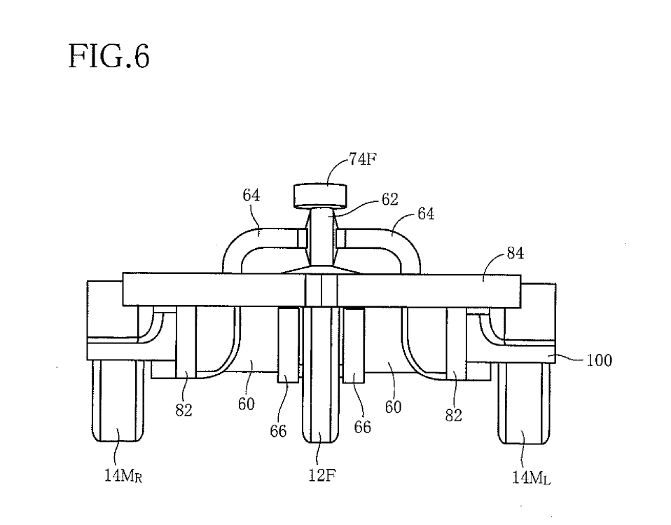

In the present vehicle, a body 42 is mounted on a chassis frame 40 that holds the four wheels 12, 14. Referring also to FIGS. 3-6, there will be explained in detail a chassis, of the present vehicle, that includes the chassis frame 40. FIG. 3 is a perspective view of the chassis. FIG. 4 is a plan view of the chassis. FIG. 5 is a side view of the chassis. FIG. 6 is a front view of the chassis.

The chassis frame 40 is a framework of the present vehicle and is a main body of the chassis structure in the present embodiment. The chassis frame 40 includes: a center frame 50, as a main beam, that is disposed so as to extend in the front-rear direction of the vehicle at the middle in the width direction of the vehicle; a front frame 52 disposed frontward of the center frame 50; and a rear frame 54 disposed rearward of the center frame 50.

The front frame 52 includes two front oblique beams 60, as a pair, fixed to a front end portion of the center frame 50. One of the two front oblique beams 60 extends toward between the front wheel 12F and the right wheel 14M_{R} while the other of the two front oblique beams 60 extends toward between the front wheel 12F and the left wheel 14M_{L}. The two front oblique beams 60 are disposed such that a distal end portion of the right-side front oblique beam 60 is located on the right side of the front wheel 12F while a distal end portion of the left-side front oblique beam 60 is located on the left-side of the front wheel 12F. Accordingly, the two front oblique beams 60 are disposed so as to sandwich the front wheel 12F therebetween.

The front frame 52 further includes a front center beam 62 that extends from the front end portion of the center frame 50 toward above the front wheel 12F. A distal end portion of the front center beam 62 is, connected to the distal end portions of the respective two front oblique beams 60 via respective connection members 64. More specifically, the two connection members 64 as a pair extend generally in the width direction of the vehicle. Each of the two connection members 64 extends between the distal end portion of the front center beam 62 and the distal end portion of a corresponding one of the two front oblique beams 60, so as to connect the front center beam 62 and the corresponding front oblique beam 60.

The front wheel 12F is held at the distal end portion of the front center beam 62. More specifically, the front wheel 12F is sandwiched and held by and between a pair of hydraulic shock absorbers 66 in the left-right direction. The front wheel 12F is rotatably held by lower end portions of the respective shock absorbers 66. Upper end portions of the respective shock absorbers 66 are fixed to a support plate 68 that extends in the width direction of the vehicle. The support plate 68 connects the upper end portions of the respective shock absorbers 66. A steering shaft 70 is fixedly provided on the support plate 68. The steering shaft 70 is rotatably held by a bearing portion 72 disposed at the distal end portion of the front center beam 62.

The steering shaft 70 extends upward from the bearing portion 72. A steering device 74F rotates a portion of the steering shaft 70 that extends upward from the bearing portion 72, whereby the front wheel 12F is steered. The steering device 74F includes an electromagnetic motor, and an operation of the electromagnetic motor is controlled, whereby the front wheel 12F is steered at an arbitrary steering angle. The front wheel 12F is configured not to be steered beyond 90 degrees in both of leftward and rightward directions by stoppers not shown.

The front frame 52 further includes a front cross member 80 that extends in the width direction of the vehicle, a pair of front side members 82 that extend in the front-rear direction of the vehicle, and a bumper reinforcement 84 that is located rearward of a bumper of the vehicle. The front cross member 80 is fixed to the front end portion of the center frame 50 so as to penetrate the center frame 50 and so as to extend in the width direction of the vehicle. One of the two front side members 82 is fixed at its rear end to the right-side end of the front cross member 80 and is fixed at its front end to the distal end portion of the right-side front oblique beam 60. The other of the two front side members 82 is fixed at its rear end to the left-side end of the front cross member 80 and is fixed at its front end to the distal end portion of the left-side front oblique beam 60. To the front ends of the respective two front side members 82, the bumper reinforcement 84 having a generally arcuate shape in plan view is fixed.

The rear frame 54 is constituted similarly to a part of the above-indicated front frame 52. To be more specific, the rear frame 54 includes: two rear oblique beams 90, as a pair, similar to the two front oblique beams 60 of the front frame 52; and a rear center beam 92 similar to the front center beam 62 of the front frame 52. The two rear oblique beams 90 are fixed to a rear end portion of the center frame 50. The two rear oblique beams 90 are disposed such that one of the two rear oblique beams 90 extends toward between the rear wheel 12R and the right wheel 14M_{R} while the other of the two rear oblique beams 90 extends toward between the rear wheel 12R and the left wheel 14M_{L}. The two rear oblique beams 90 are disposed such that a distal end portion of the right-side rear oblique beam 90 is located on the right side of the rear wheel 12R while a distal end portion of the left-side rear oblique beam 90 is located on the left side of the rear wheel 12R, so as to sandwich the rear wheel 12R therebetween. The rear center beam 92 is disposed so as to extend from the rear end portion of the center frame 50 toward above the rear wheel 12R. The distal end portion of the rear center beam 92 is connected to distal end portions of the respective two rear oblique beams 90 via respective connection members 94. The rear wheel 12R is held at the distal end portion of the rear center beam 92 owing to a structure similar to a structure by which the front wheel 12F is held by the front center beam 62. The rear wheel 12R is configured to be steered by a steering device 74R provided therefor.

The rear frame 54 further includes a rear cross member 96 that extends in the width direction of the vehicle. The rear cross member 96 is fixed to the rear end portion of the center frame 50 so as to penetrate the center frame 50 and so as to extend in the width direction of the vehicle.

The chassis frame 40 is of the so-called platform type and includes a floor pan 100 as a floor board that defines the lower surface of the vehicle cabin, in addition to the center frame 50, the front frame 52, and the rear frame 54 explained above. The floor pan 100 is fixed to an upper surface of the front cross member 80 and an upper surface of the rear cross member 96, on the right side and the left side of the center frame 50. The center frame 50, the two front oblique beams 60, and the two rear oblique beams 90 has the same dimension in the up-down direction and are disposed at the same height level. That is, as apparent from FIGS. 3 and 5, the center frame 50, the two front oblique beams 60, and the two rear oblique beams 90 extend upward from the floor pan 100. As apparent from FIG. 4, on the upper surface of the floor pan 100, the seats 20, 22 are provided respectively on the right side and the left side of the center frame 50. In the present vehicle, a front end of the cabin interior space is defined frontward of the accelerator pedal 32 and the brake pedal 34, and the two front oblique beams 60 are disposed such that the distal end portions of the respective two front oblique beams 60 are located frontward of the cabin interior space.

### <Effects of Chassis Structure>

The vehicle in which the thus configured chassis structure is used is the diamond-shaped wheel-arrangement vehicle. In such a vehicle, a collision at the left front portion and the right front portion of the vehicle that are oblique relative to the front-rear direction or a collision at the left rear portion and the right rear portions of the vehicle that are oblique relative to the front-rear direction, i.e., the so-called offset collision, poses a serious problem, as compared with an ordinary vehicle in which the wheels are disposed at the respective four corners. In the vehicle in which the present chassis structure is used, the four corners of the vehicle are rounded, as shown in FIG. 2, and a stroke amount for absorbing an impact upon the offset collision is accordingly small. Accordingly, the offset collision is particularly serious. In the vehicle in which is used the chassis structure constructed as described above, the two front oblique beams 60 are disposed respectively between the front wheel 12F and the left wheel 14M_{F} and between the front wheel 12F and the right wheel 14M_{R}. Further, the two rear oblique beams 90 are disposed respectively between the rear wheel 12R and the left wheel 14M_{L} and between the rear wheel 12R and the right wheel 14 M_{R}. Accordingly, even in the event of the offset collision, the vehicle is prevented from being deformed owing to the two front oblique beams 60 and the two rear oblique beams 90, whereby the safety of the vehicle occupant can be ensured.

The present chassis structure is configured such that the center frame 50 supports the two front oblique beams 60 on the rear side thereof in a collision at the front portion of the vehicle and such that the center frame 50 supports the two rear oblique beams 90 on the front side thereof in a collision at the rear portion of the vehicle. Therefore, the strength of the present vehicle is high in the front-rear direction, whereby the safety of the vehicle occupant is enhanced. Further, because the center frame 50 is disposed at the middle in the width direction of the vehicle, there is ensured large spaces in the present vehicle for respectively disposing the suspension apparatuses for the left and right wheels 14 and there is ensured a high degree of freedom in designing the suspension apparatuses for the left and right wheels 14. Moreover, the center frame 50 has a relatively large size and a relatively large weight and is disposed near the gravity center position of the vehicle body. Accordingly, the moment of inertia in yawing or rolling of the vehicle is made small. In other words, the vehicle in which the present chassis structure is used is excellent in running stability and maneuverability.

The center frame 50, the two front oblique beams 60, and the two rear oblique beams 90 are disposed so as to protrude upward from the floor pan 100. In other words, the floor pan 100 is located at a height level lower than the upper surfaces of the center frame 50, the two front oblique beams 60, and the two rear oblique beams 90. According to the arrangement, the gravity center position of the vehicle body is made low in the present vehicle, as compared with an arrangement in which the floor pan 100 is provided on the upper surfaces of the center frame 50, the two front oblique beams 60, and the two rear oblique beams 90. Further, the seats 20, 22 are disposed on the low floor pan 100, so that the present vehicle ensures ease of ingress and egress. Moreover, while the present vehicle is a small-sized vehicle as described above, the height positions, as measured from the ground surface, of the center frame 50, the front oblique beams 60, and the rear oblique beams 90 are not low, and accordingly the center frame 50, the front oblique beams 60, and the rear oblique beams 90 are located at the height positions close to the height position of a bumper of an average-sized vehicle. Therefore, in the present vehicle, deformation of the vehicle in a collision with other vehicle can be suppressed with high reliability owing to the center frame 50, the two front oblique beams 60, and the two rear oblique beams 90.

### Modified Example

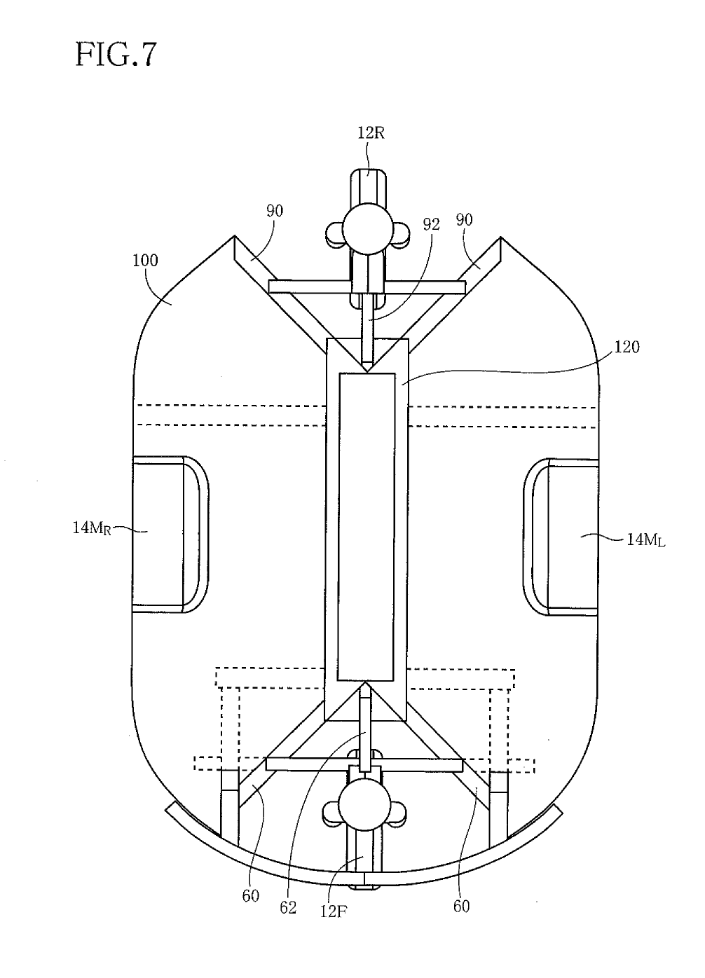

In the chassis structure according to the illustrated first embodiment, the center frame 50 as the main beam is a simple square columnar member. In the chassis structure according to a modified example shown in FIG. 7, a center frame 120 is a frame-like member having a quadrilateral (rectangular) shape in plan view. In the vehicle, the battery, the auxiliary equipment, and so on are disposed inside the center frame 120. That is, according to the chassis structure of the modified example, the battery, the auxiliary equipment, and so on disposed inside the center frame 120 can be protected with high reliability in a collision of the vehicle. Further, various equipment is disposed near the gravity center position of the vehicle body, so that the moment of inertia in yawing and rolling of the vehicle is made small.

The chassis structure according to the illustrated first embodiment and the modified example is used in the vehicle in which the chassis frame 40 as the framework of the vehicle is separate from the body 42, namely, the vehicle of the so-called separate frame type. The chassis structure according to the illustrated first embodiment and the modified example may be used in a vehicle in which the chassis frame is formed integrally with the body, namely, a vehicle of the so-called frameless body type (such as a monocoque body type).

### Second Embodiment

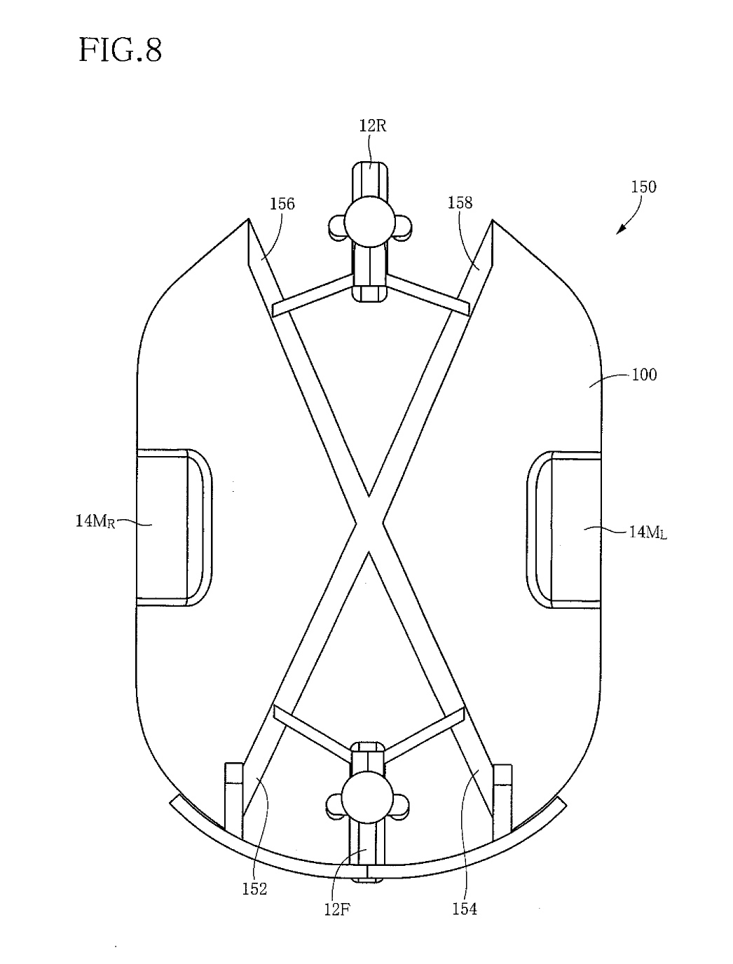

FIG. 8 is a plan view showing chassis of a vehicle in which is used a chassis structure according to a second embodiment. In the following explanation of the chassis structure according to the second embodiment, the same reference numerals as used in the illustrated first embodiment are used to identify the corresponding components, and explanation thereof is dispensed with or simplified.

A chassis frame 150 as a main body of the chassis structure of the second embodiment includes four oblique beams 152, 154, 156, 158. The oblique beam 152 extends from the center of the vehicle toward between the front wheel 12F and the right wheel 14M_{R}. The oblique beam 154 extends from the center of the vehicle toward between the front wheel 12F and the left wheel 14M_{L}. The oblique beam 156 extends from the center of the vehicle toward between the rear wheel 12R and the right wheel 14M_{R}. The oblique beam 158 extends from the center of the vehicle toward between the rear wheel 12R and the left wheel 14M_{L}. The four oblique beams 152, 154, 156, 158 are fixed at the center of the vehicle. In other words, the framework of the chassis structure of the second embodiment is formed in an X-letter shape by the four oblique beams 152, 154, 156, 158 and does not have the main beam as provided in the chassis structure of the first embodiment. The two oblique beams 152, 154 that extend toward the front portion of the vehicle function as two front oblique beams as a pair while the two oblique beams 156, 158 that extend toward the rear portion of the vehicle function as two rear oblique beams as a pair.

Accordingly, as in the vehicle in which the chassis structure according to the first embodiment is used, in the vehicle in which the chassis structure according to the second embodiment is used, deformation of the vehicle can be suppressed even in the event of the offset collision, owing to the two front oblique beams 152, 154 and the two rear oblique beams 156, 158, whereby the safety of the vehicle occupant is ensured. Further, in the chassis structure according to the second embodiment, rear end portions of the respective two front oblique beams are fixed directly to front end portions of the respective two rear oblique beams, so that the chassis structure is simple in configuration, as compared with the chassis structure of the first embodiment.

### DESCRIPTION OF REFERENCE SIGNS

12F: front wheel (steerable wheel) 14M_{L}: left wheel 14M_{R}: right wheel 12R: rear wheel (steerable wheel) 20,22: seats (a pair of seats) 40: chassis frame 42: body 50: center frame (main beam) 52: front frame 54: rear frame 60: front oblique beams 62: front center beam 64: connection member (connection beam) 70: steering shaft 74: steering device 90: rear oblique beams 92: rear center beam 94: connection member (connection beam) 100: floor pan (floor board) 120: center frame (main beam) 150: chassis frame 152, 154: oblique beams (front oblique beams) 156, 158: oblique beams (rear oblique beams)

1-16. (canceled)

17. A chassis structure used in a vehicle having (a) a single front wheel that is disposed at a middle of a front portion of the vehicle in a width direction of the vehicle, (b) a left wheel and a right wheel that are respectively disposed at a left portion and a right portion of the vehicle and that are located rearward of the front wheel, and (c) a single rear wheel disposed rearward of the left wheel and the right wheel, the chassis structure being for holding the front wheel, the right wheel, the left wheel, and the rear wheel and comprising:
two front oblique beams as a pair that are disposed so as to sandwich the front wheel therebetween, one of the two front oblique beams extending from a central portion of the chassis structure surrounded by the front wheel, the right wheel, the left wheel, and the rear wheel toward between the front wheel and the right wheel such that a distal end portion of the one of the two front oblique beams is located on a right side of the front wheel while the other of the two front oblique beams extends from the central portion toward between the front wheel and the left wheel such that a distal end portion of the other of the two front oblique beams is located on a left side of the front wheel; and
two rear oblique beams as a pair that are disposed so as to sandwich the rear wheel therebetween, one of the two rear oblique beams extending from the central portion toward between the rear wheel and the right wheel such that a distal end portion of the one of the two rear oblique beams is located on a right side of the rear wheel while the other of the two rear oblique beams extends from the central portion toward between the rear wheel and the left wheel such that a distal end portion of the other of the two rear oblique beams is located on a left side of the rear wheel.

18. The chassis structure according to claim 17, wherein each of the two front oblique beams is disposed such that the distal end portion thereof is located frontward of a cabin interior space formed in the vehicle in which the chassis structure is used.

19. The chassis structure according to claim 17, further comprising a front center beam disposed so as to extend from the central portion toward above the front wheel.

20. The chassis structure according to claim 19, further comprising connection beams each of which extends between a distal end portion of the front center beam and the distal end portion of a corresponding one of the two front oblique beams so as to connect the front center beam and the corresponding one of the two front oblique beams.

21. The chassis structure according to claim 19,
wherein the front wheel is a steerable wheel, and
wherein a steering shaft of the front wheel is held at the distal end portion of the front center beam.

22. The chassis structure according to claim 17, further comprising a main beam disposed at the central portion so as to extend in a front-rear direction of the vehicle,
wherein each of the two front oblique beams is fixed at a rear end portion thereof to a front end portion of the main beam so as to extend from the main beam while each of the two rear oblique beams is fixed at a front end portion thereof to a rear end portion of the main beam so as to extend from the main beam.

23. The chassis structure according to claim 17, wherein front end portions of the respective two rear oblique beams and rear end portions of the respective two front oblique beams are fixed to one another at the central portion.

24. The chassis structure according to claim 22, further comprising a floor board,
wherein the main beam is disposed so as to protrude upward from the floor board.

25. The chassis structure according to claim 22, wherein the two front oblique beams and the main beam are located in one plane.

26. The chassis structure according to claim 22, wherein the main beam is a frame-like member having a quadrilateral shape as viewed from above.

27. A chassis structure used in a vehicle having a single front wheel that is disposed at a middle of a front portion of the vehicle in a width direction of the vehicle and a left wheel and a right wheel that are respectively disposed at a left portion and a right portion of the vehicle and that are located rearward of the front wheel, the chassis structure being for holding the front wheel, the right wheel, and the left wheel and comprising:
two front oblique beams as a pair that are disposed so as to sandwich the front wheel therebetween, one of the two front oblique beams extending from a central portion of the chassis structure surrounded by the front wheel, the right wheel, and the left wheel toward between the front wheel and the right wheel such that a distal end portion of the one of the two front oblique beams is located on a right side of the front wheel while the other of the two front oblique beams extends from the central portion toward between the front wheel and the left wheel such that a distal end portion of the other of the two front oblique beams is located on a left side of the front wheel;
a front center beam disposed so as to extend from the central portion toward above the front wheel; and
connection beams each of which extends between a distal end portion of the front center beam and the distal end portion of a corresponding one of the two front oblique beams so as to connect the front center beam and the corresponding one of the two front oblique beams.
